(19) United States
(12) Patent Application Publication
(10) Pub. No.: US 2010/0196843 A1
(43) Pub. Date: Aug. 5, 2010

(54) DENTAL TREATMENT DEVICE

(76) Inventor: Burghardt Krebber, Landsberg/Lech (DE)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/593,284

(22) PCT Filed: Mar. 28, 2008
(86) PCT No.: PCT/EP08/02517

§ 371 Date: Mar. 22, 2010

(30) Foreign Application Priority Data
Mar. 28, 2007 (EP) EP07006420.9
May 23, 2007 (EP) EP07010242.1
Nov. 29, 2007 (EP) EP07023185.7

(51) Int. Cl. A61C 19/06

(52) U.S. Cl. 433/82

(57) ABSTRACT

A device for treating a dental tissue with a continuous flow of ozone containing gas, comprising (a) an ozone generator (2) for generating an ozone containing gas, (b) a first pump (1) being in fluid flow communication with the ozone generator for generating a flow of ozone containing gas, (c) an applicator (3) for multiple teeth having a surface suitable for forming with the hard and soft dental tissue of multiple teeth to be treated a treatment chamber having an inlet orifice being in fluid flow communication with the ozone generator (2) and the first pump (1) and having an outlet orifice, and (d) a second pump (5) being in fluid flow communication with the outlet orifice of the applicator (3) for removing gas from the treatment chamber, whereby said second pump (5) has a second throughput and the first pump (1) has a first throughput whereby the ratio of the second throughput to the first throughput is at least 1.5:1.

### FIELD OF THE INVENTION

The present invention relates a device for treating dental hard and soft tissues with a flow of ozone containing gas. The present invention also relates to an applicator for such a device. Moreover, the present invention further relates to a method of treatment of dental hard and soft tissues of a patient by applying a continuous pulsing flow of ozone. Finally, the present invention relates to a method of treatment of a dental tissue of a patient by applying a continuous flow of ozone containing gas.

### BACKGROUND OF THE INVENTION

US2006/01 10710 discloses an endodontic ozone therapy.

Decay of hard dental tissue is caused by microorganisms propagating in the vicinity of the hard dental tissue. Dental caries is based on the acid dissolution of enamel, dentine or cementum as a consequence of the metabolism of microorganisms living within deposits on the teeth known as plaque. Moreover, infections of soft dental tissue are caused by microorganisms propagating in the soft dental tissue.

In order to interrupt the progress of hard dental tissue decay, the decayed hard dental tissue including the microorganisms are commonly removed by a drilling treatment and the cavities thereby formed are sealed and filled with a restorative material. Dental treatment by drilling a tooth causes significant discomfort and anxiety to the patient. Moreover, the drilling treatment not only removes decayed dental tissue, but also healthy dental tissue. In addition, materials used for restorations may be problematic in that e.g. gold and ceramic are expensive and present a technical challenge for the practitioner whereas amalgam is potentially toxic and may cause allergic reactions. Therefore, alternative methods for the control of bacterial growth on and inside hard and soft dental tissue are desired.

In this context, the application of ozone to dental tissue was considered. W002078644 suggests the use of ozone in the treatment of dental and oral conditions. Ozone is a strongly oxidizing gas having bactericidal effects. However, ozone is also a highly toxic gas which may lead to severe poisoning when inhaled by a patient. Therefore, the application of ozone to hard and soft dental issue in the mouth of the patient requires applicator devices which are suitable for delivering a sufficiently high ozone concentration to the decaying dental tissue while at the same time avoiding contamination of the patient.

A dental applicator is known (OzonyTron commercially available from Mymed, Germany and DE 20 2005 012 281 U1) which generates small amounts of ozone gas in a glass nozzle to be positioned in dose proximity to the dental tissue to be treated. The ozone diffuses from an orifice of the nozzle so that a concentration gradient is formed wherein a bactericidally effective dose of ozone can only be expected within a distance of less than 3 mm from the orifice. According to this technology, a flow of ozone containing gas is not used. Given that only minor amounts of ozone are generated by the device and given that the treatment time does not exceed about 40 seconds, the risk of a contamination of the patient with ozone is believed to be acceptable despite the use of an open system. However, ozone is inevitably inhaled by the patient since means for eliminating gaseous ozone from the mouth of the patient are not provided. Furthermore, micro currents due to the ozone generation in a plasma inside the applicator nozzle placed in dose proximity to the dental issue may be felt by the patient as an uncomfortable side effect. Finally, since the nozzle is made of a delicate glass structure, the device may break during the application of ozone.

A further dental applicator is known which uses a silicon cup placed on a dental surface to be treated. The silicon cup is connected to a vacuum pump for creating a vacuum inside a treatment chamber defined by the sleeve and the dental surface to be treated. The silicon cup forms a tight seal when a vacuum is applied. As soon as a predetermined vacuum is established, the device generates ozone and releases small amounts inside the treatment chamber for treatment of the dental surface. Ozone generation is discontinued when the pressure inside the silicon cup rises, indicating a leakage of the seal. Therefore, the performance of the applicator depends on the quality of the tight seal formed between the silicon cup and the dental surface to be treated. Given that decaying dental surfaces may not be able to form a tight seal due to the complicated surface topology, the tight seal may often not be reliably formed so that an application of ozone does not efficiently take place. As a remedy, a range of different silicone cups are provided which lead to further complications of the procedure.

Known dental applicators are not capable of administering ozone over an extended period of time so that a significant amount of ozone may be safely and efficiently delivered to decaying dental tissue in the treatment of deep caries, gingivitis and parodontitis.

Moreover, known dental applicators are not capable of treating a large dental surface over an extended period of time without the risk of contamination of the patient.

Finally, known dental applicators are not able of administering ozone over an extended period of time to soft tissue and saliva so that a significant amount of ozone may be safely and efficiently delivered and reach infected soft dental tissue gingivitis parodontitis and by diffusion in the treatment of granuloma.

### SUMMARY OF THE INVENTION

It is the problem of the present invention to provide a device for safely and efficiently treatment of hard and soft dental tissues with a pulsing flow of ozone.

A further problem of the present invention is to provide a device for treating hard and soft dental tissues with a puling flow of ozone over an extended period of time with a device which may be easily hand led and does not cause discomfort to the patient.

It is a further problem of the present invention to provide a device for treating a large surface of hard and soft dental tissues or a dental surface which is difficult to access with a pulsing flow of ozone over an extended period of time.

The present invention provides a device for treating dental hard and soft tissues with a continuous pulsing flow of ozone containing gas, comprising

(a) an ozone generator for generating an ozone containing gas,

(b) a first pump being in fluid flow communication with the ozone generator for generating a flow of ozone containing gas,

(c) an applicator having a surface suitable for forming a chamber with the dental tissue and gums to be treated and inner wall of the applicator. A treatment chamber having at least one inlet orifice being in fluid flow communication with the ozone generator and the first pump and having at least one outlet orifice, and

(d) a second pump being in fluid flow communication with the outlet orifice of the applicator for removing gas from the treatment chamber, whereby said second pump has a second throughput and the first pump has a first throughput whereby the ratio of the second throughput to the first throughput is at least 1.5:1.

The present invention is based on the recognition that dental caries, parodontitis gingivitis and granuloma (pus at the teeth roots or in gums) and more may be treated by exposing a dental tissue suffering from undesired bacterial growth to a continuous flow of ozone containing gas, preferably a continuous pulsing flow of ozone containing gas. In case of deep dental caries, parodontitis, gingivitis and granuloma, ozone may diffuse across plaque or hard and soft tissue before reaching the microorganisms.

Moreover, the present invention is based on the recognition that the success of space between the teeth, the root canals, and the cavities treatment may be significantly increased when the space between the teeth, the root canals, and the cavities is treated with a pulsing flow of ozone containing gas.

The present invention is further based on the recognition that a pulsing continuous flow of ozone may be applied to a dental surface over an extended period of time without the risk of contamination of the patient when a combination of two pumps is used so that a first pump having a first throughput introduces an ozone containing gas into a treating chamber whereby a second pump having a higher throughput removes ozone containing gas from the treating chamber including air which has entered into the treating chamber through not tight portions of the seal between the applicator and the dental tissue or the gums. The dental applicator forming the treating chamber is normally a prefabricated (by an injection moulding machine) applicator for repeated applications of ozone in the prevention and/or treatment of dental caries, gingivitis, parodontitis and granuloma or any infection in the gums.

A special dental applicator may be adapted to the dentition of a specific patient. The present invention uses a partial pressure of ozone in the ozone containing gas which is in a range previously unattainable when applying a vacuum and too dangerous to use in an open system. The high partial pressure of ozone in the continuous, preferably pulsing, flow of oxygen as provided by the device of the present invention forces the ozone deep into the dental tissue and gums whereby an efficient treatment of deep caries, gingivitis, parodontitis and granuloma or any infection in the gums is possible without the need for drilling treatment or surgery. Accordingly it is possible to efficiently interrupt infection and decay of dental tissue or gums due to bacteria eliminating while at the same time avoiding the pain and anxiety associated with a drilling treatment and surgery as well as avoiding unnecessary loss of healthy dental tissue or entire teeth.

The present invention also provides an applicator for a device according to the invention.

### BRIEF DESCRIPTION OF THE FIGURES

FIG. 1 is a schematic representation of an embodiment of the device according to the invention.

### DESCRIPTION OF THE PREFERRED EMBODIMENTS

The present invention provides a device for treating a dental tissue and gums with a continuous flow of ozone containing gas, preferably a continuous pulsing flow of ozone containing gas. The gas may be air having an oxygen content in the range of from 20 to 99 percent by volume. Accordingly, pure air may preferably be used for the ozone generator or a mixture comprising air and additional pure oxygen gas.

The dental tissue to be treated includes hard and soft tissues. Hard tissue includes dentin and enamel as well as any restoration permanently provided on the dentin or enamel. Soft tissue includes any tissue in the mouth which is not hard tissue including gums, the inside of pockets formed by the soft tissue. Treatment of dental tissue within the meaning of the present invention includes the exposure of dental surfaces to ozone molecules in a concentration suitable for controlling bacterial growth. Preferably, the treatment also includes the penetration of the dental surface by the ozone so that bacterial growth below the surface of the dental tissue and the gums may be controlled. Since anaerobic bacteria propagate in an environment where oxygen is not available, the treatment according to the present invention may be directed to providing an exposure of such bacteria even in such anaerobic environments. For this purpose, the dental tissue is exposed to a high ozone partial pressure over a prolonged period of time. Accordingly, it is possible to not only treat and prevent caries and other infections to the surface, but also to control bacteria causing caries in layers below the dental and gum tissue surfaces.

The device according to the invention comprises an ozone generator for generating an ozone containing gas. The ozone generator may be a conventional ozone generator using an electric discharge for cleaving oxygen molecules in a plasma. Preferably, the ozone generator allows controlling the rate of ozone generation in order to adjust the ozone concentration in the ozone containing gas. The ozone containing gas generated by the ozone generator preferably has an ozone concentration of from 50 to 20.000 ppm, more preferably an ozone concentration of from 100 to 10.000 ppm. For safety reasons, the ozone generator is preferably arranged in series with the first and the second pump so that the ozone generator may only be activated when the pumps are running so that a flow of gas is present which prevents the ozone from being discharged from the ozone generator in an uncontrolled manner.

The device according to the present invention further comprises a first pump being in fluid flow communication with the ozone generator for generating a flow of ozone containing gas. Preferably, the first pump (1) arranged so as to discharge a stream of gas such as air into the ozone generator for providing a continuous flow of ozone containing gas downstream from the first pump. The first pump has a first throughput.

Moreover, the first pump has a first pumping speed. Preferably, the first pump has a pumping speed in the range of from 1 to 10 I/min, more preferably from 2 to 6 I/min.

The device according to the present invention further comprises an applicator available in different sizes having a surface suitable for forming with the dental tissue and the gums to be treated a chamber having at least one inlet orifice being in fluid flow communication with the ozone generator and the first pump and having at least one outlet orifice. being in fluid flow communication with the second pump.

The first preferred embodiment is an applicator prefabricated by injection moulding machines, available in different sizes. It is to be used for the complete row of teeth, both for the upper and lower jaw. The applicator may be U-shaped. The applicator may be designed to fit to nearly all patients. In a typical implementation of an applicator, the ozone containing gas is led through an orifice to the front teeth. The ozone flows right and left along the teeth in the direction of the ends of the applicator. A second orifice in the front side of the applicator may be connected to invisible integrated ducts in the applicator wall. These ducts may lead to the right and left ends of the applicator. At the ends of the applicator these ducts are open to the inside of the applicator from where the gas with remaining ozone is sucked out of the applicator. Due to the higher outgoing suction power compared to the incoming pressure, no ozone gets into the patient's mouth. Hence, no ozone can be inhaled by the patient. The applicator should consists of sterilizable material.

In a further preferred embodiment, the applicator according to the present invention is a custom made applicator which is adapted to the teeth of a specific patient

Moreover, the device of the present invention may further comprise a moisture trapping means which is in fluid communication with the outlet orifice of the applicator for removing gas from the treatment chamber. The moisture trapping means may be a container were the input orifice is separated from the output orifice so that the moisture remains in the container and the moisture is separated from the ozone containing gas.

Alternatively, the container may contain a drying agent or a cold surface for eliminating any water vapour remaining in the flow of ozone containing gas discharged from the treatment chamber before entering the second pump.

The device according to the present invention further comprises a second pump being in fluid flow communication with the outlet of the moisture trapping means. The second pump has a second throughput. The ratio of the second throughput to the first throughput is at least 1.5:1, preferably 2:1. Moreover, the second pump preferably has a pumping speed in the range of from 1.5 to 15 I/min. In one embodiment, the activation of the second pump is a necessary condition for the possibility of activating the ozone generator so that the contamination of the patient may be excluded.

The device of the present invention may further comprise an ozone scavenging means which is in fluid communication with the outlet orifice of the second pump. The scavenging means may contain a reducing agent which eliminates any ozone remaining in the flow of ozone containing gas discharged from the treatment chamber.

The device of the present invention may further comprise one or more control means for controlling the throughput of the first and/or second pump. The one or more control means of the device of the present invention may periodically change the ratio of the first throughput to the second throughput so that the speed of the continuous flow and consequently the pressure of ozone containing gas periodically changes in the treatment chamber. For instance, the second pump can be switched off all 2 seconds for 0.3 second. Furthermore, the one or more control means may periodically reduce the throughput followed by an increase of the throughput of the pump. The reduction and increase of the throughput may occur with a frequency of from 1 to 200 cycles per minutes, preferably from 20 to 40 cycles, or, in another embodiment, 30 cycles per minute. The periodical changes of the speed of the continuous flow of ozone containing gas in the treatment chamber by one or more control means improves the contact of dental surfaces in the treatment chamber with ozone and thereby increases the efficiency of the treatment. So the ozone can penetrate the space between the teeth, the root canals, the cavities and more.

In a device of the invention, the ozone generator, the first pump the second pump, the scavenging means and the control means may be provided in a housing. At the front panel side of the housing there is a hollow forming lid, which is connected to the housing by a hinge. The lid is easy to open and close as a reversibly sealable hollow chamber. During the treatment of the patient the lid is open and so it gives access to front panel, where all required controls are installed.

Subsequent to the treatment of the patient, the device of the invention may be contaminated and needs to be sterilized.

For sterilizing purposes the reversibly sealable chamber is closed and the interior of the chamber being in fluid communication with the ozone generator, whereby the inner wall of the chamber at least partially comprises surfaces of the device exposed to the environment during use of the device for treating a dental tissue.

For this sterilizing purpose, the means for controlling the operation of the ozone generator, the first pump and the second pump, when the reversibly sealable chamber is sealed may be set so as to introduce ozone into the reversibly sealable chamber over a predetermined period of time. During this period, the reversibly sealable chamber may further contain the applicator, tubing or other contaminated devices.

After the predetermined period of time, any excess ozone contained in the reversibly sealable chamber may be eliminated by either reversing the sealing of the chamber, or by using one or more orifices in the housing provided for eliminating ozone contained in the reversibly sealable chamber after the treatment of surfaces of the device exposed to the environment during use of the device for treating a dental tissue. The need for additional sterilizing equipment is not required.

Moreover, the housing may comprise one or more orifices for eliminating ozone contained in the reversibly sealable chamber after the treatment of surfaces of the device exposed to the environment during use of the device for treating a dental tissue.

The device according to the present invention may be part of a system comprising a device for treating a dental tissue with a continuous pulsing flow of ozone containing gas, and a plurality of applicators.

The device for treating a dental tissue with a continuous pulsing flow of ozone containing gas may be used as follows.

Prior to activating the ozone generator the applicator is placed in the patient's mouth so that a treating chamber is formed by the inner surface of the applicator and the hard and soft dental tissue and the gums to be treated. Subsequently, a gas flow may be initiated by activating the first pump and the second pump. Provided that the gas flow is established, the ozone generator may be activated. Accordingly the flow of gas then will include an amount of ozone to which the dental surface and the gums inside the treating chamber are exposed. The treatment of dental tissue and gums of a patient by applying a continuous pulsing flow of ozone for a period of time may be applied for an adjustable predetermined time in the range of from 1 minute to 60 minutes. During the treatment of the patient, the continuous flow of ozone containing gas may be applied by periodically pulsing changing the flow speed of gas.

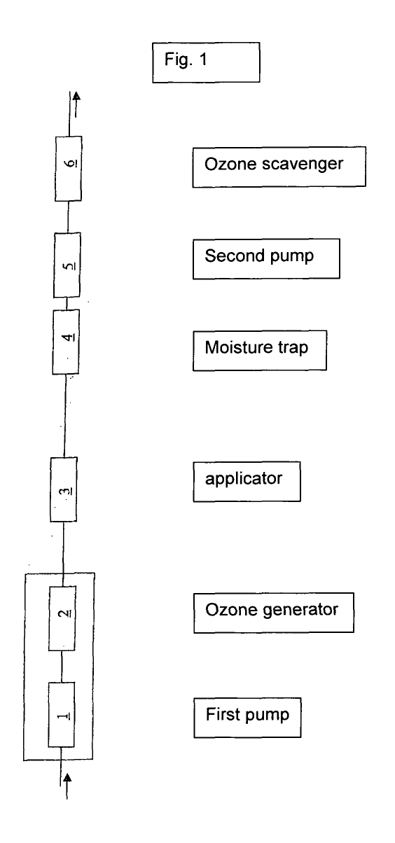

FIG. 1 shows a schematic representation of a preferred embodiment of the device according to the invention. A first pump 1 is in fluid communication with an ozone generator 2. The first pump 1 and the ozone generator 2 may be combined in a single device for providing a flow of ozone gas. The ozone generator 2 is in fluid flow communication with the dental applicator 3. The dental applicator 3 is in fluid flow communication with a moisture trapping means 4 which dries the flow of gas from the dental device. The moisture trapping means 4 is in fluid flow communication with the second pump 5. The output of the second pump 5, which is a suction pump for the applicator, is in fluid flow communication with an ozone scavenging means 6 for eliminating excess ozone present in the flow of gas.

1. A device for treating a dental tissue with a continuous flow of ozone containing gas, comprising:
(a) an ozone generator for generating an ozone containing gas;
(b) a first pump being in fluid flow communication with the ozone generator for generating a flow of ozone containing gas;
(c) an applicator for multiple teeth having a surface suitable for conforming to hard and soft dental tissue of multiple teeth to be treated;
wherein the applicator includes a treatment chamber having at least one inlet orifice being in fluid flow communication with the ozone generator and the first pump and having at least one outlet orifice; and
(d) a second pump being in fluid flow communication with the outlet orifice of the applicator for removing gas from the treatment chamber, whereby said second pump has a second throughput and the first pump has a first throughput whereby the ratio of the second throughput to the first throughput is at least 1.5:1.

2-3. (canceled)

4. The device according to claim 1, wherein the ozone containing gas generated by the ozone generator has an ozone concentration of from 50 to 20000 ppm.

5. (canceled)

6. The device according to claim 1, wherein the first pump has a pumping speed in the range of from 1 to 10 l/min.

7. The device according to claim 3, wherein the second pump has a pumping speed in the range of from 1.5 to 15 l/min.

8. The device according to claim 1, further comprising: (e) a moisture trapping means downstream from the outlet orifice of the applicator and upstream from the second pump.

9. The device according to claim 1, further comprising an ozone scavenging means downstream from the second pump.

10. The device according to claim 1, further comprising a prefabricated applicator.

11. A system for treating a dental tissue comprising a device according to claim 1 and further comprising a plurality of applicators, preferably of different sizes.

12. A method of treatment of a dental tissue, the method comprising:
providing a continuous flow of ozone containing gas to dental tissue for a period of 30 seconds to 60 minutes.

13. (canceled)

14. The device according to claim 1, wherein the one or more control means periodically changes the ratio of the second throughput to the first throughput by interrupting the second pump, so that the speed and pressure of the continuous flow of ozone containing gas periodically changes in the treatment chamber, and
further comprising one or more control means for controlling the throughput at least one of the first pump and second pump.

15. The device according to claim 10, wherein the one or more control means periodically reduces the throughput followed by an increase of the throughout of the pump.

16. The device according to claim 11, wherein the reduction and increase of the throughput occurs with a frequency of from 1 to 200 cycles per minutes.

17. The method according to claim 9, wherein the continuous flow of ozone containing gas for a period of time in the range of from 30 seconds to 60 minutes is applied by periodically changing the flow speed and accordantly the pressure of the gas.

18. The method according to claim 13, wherein providing a continuous flow of ozone containing gas to dental tissue is accomplished using the device of claim 1.

19. The device according to claim 1, wherein the ozone generator, the first pump and the second pump are provided in a housing and whereby the housing further contains a reversibly sealable chamber being in fluid communication with the ozone generator, whereby the inner wall of the chamber at least partially comprises surfaces of the device exposed to the environment during use of the device for treating a dental tissue.

20. The device according to claim 15, further comprising a means for controlling the operation of the ozone generator, the first pump and the second pump, when the reversibly sealable chamber is sealed.

21. The device according to claim 15, wherein the reversibly sealable chamber may further contain the applicator, tubing or other contaminated devices.

22. (canceled)

23. The method according to claim 9, further comprising treating a surface of the device with ozone, said surface being exposed to the environment during use of the device for treating a dental tissue, and forming a portion of an inner wall of a reversibly sealable chamber being in fluid communication with the ozone generator.

24. The method according to claim 18, wherein the treatment of the surface being exposed to the environment during use of the device for treating a dental tissue is controlled by a means for controlling the operation of the ozone generator, the first pump and the second pump, when the reversibly sealable chamber is sealed.

25-26. (canceled)

27. The device according to claim 1, wherein the one or more control means periodically changes the ratio of the second throughput to the first throughput in a range of from 6:1 to 1.5:1 so that the speed and/or pressure of the continuous flow of ozone containing gas periodically changes in the treatment chamber, and
further comprising one or more control means for controlling the throughput at least one of the first pump and second pump.
